(19) United States
(12) Patent Application Publication
(10) Pub. No.: US 2020/0262063 A1
(43) Pub. Date: Aug. 20, 2020

(54) MULTI-TENANT DASHBOARD FOR ROBOTIC PROCESS AUTOMATION SYSTEMS

(71) Applicant: Roots Automation, Inc., New York, NY (US)

(72) Inventors: Charith J Perera, Brooklyn, NY (US); John Cottongim, New York, NY (US)

(21) Appl. No.: 16/792,856

(22) Filed: Feb. 17, 2020

Related U.S. Application Data
(60) Provisional application No. 62/806,063, filed on Feb. 15, 2019.

(51) Int. Cl. B25J 9/16

(52) U.S. Cl. CPC B25J 9/1661; G05B 2219/50391; G05B 2219/50123

(57) ABSTRACT

A system providing a multi-tenant dashboard for allowing multiple users across a variety of tenants to access, view and report on the progress and performance of a robotic process automation system. Through the multi-tenant dashboard at least one tenant is established with identifying information. One or more users are assigned within the at least one tenant profile having a unique role and a unique a set of process steps to complete. The multi-tenant dashboard further provides a triggering system for evaluation and completion of set of process steps assigned to each user. Messages are sent through a messaging system notifying the at least one tenant of status of the automated processing system based on execution of the set of process steps.

### CROSS REFERENCE TO RELATED APPLICATIONS

This application claims the benefit of U.S. Provisional Patent Application 62/806,063, filed Feb. 15, 2019, which is incorporated by reference herein in its entirety.

### BACKGROUND OF THE INVENTION

### Field of the Invention

The present invention relates to multi-tenant dashboards, and more particularly to a multi-tenant dashboard that allows users across a variety of tenants to access, view and report on the progress and performance of a robotic process automation system.

### Related Art

Currently, companies providing robotic process automation services are required to develop multiple instances of the same robotic process automation dashboard to segregate information of one customer from that of another customer. Robotics process automation service providers also are required to develop custom views within each dashboard to effectively present the performance metrics associated with each robotic process. Additionally, robotic processes are presently started and stopped according to a predefined schedule and a tenant has no ability to identify an idle robotic process and prompt the process to initiate or resume.

As can be seen, there is a need for an improved system, apparatus, and method to provide robotic process automation services in a multi-tenant environment.

### SUMMARY OF THE INVENTION

It is to be understood that the phraseology and terminology employed herein are for the purpose of this description only and should not be regarded as limiting.

The present invention is directed to a multi-tenant dashboard system for allowing a plurality of tenants to execute and evaluate automated robotic processes within a robotic process automation system. The multi-tenant dashboard system comprising a multi-tenant architecture, a multi-role architecture, one or more layered process outlines, and a triggering system. The robotics process automation system operates on a first computing device and is configured to execute a set of business rules using one or more robotics processing machines. The first computing device includes a memory storing instructions and a hardware processor coupled to the memory. The hardware processor is configured by the instructions to establish at least one tenant profile with identifying information, establish one or more users within the at least one tenant profile, assign roles to each of the one or more users within the at least one tenant profile, execute a set of process steps unique to each user, and send messages through a messaging service notifying the at least one tenant of the status of a robotic process.

These and other aspects of the present invention will become readily apparent upon further review of the specification and drawings.

### BRIEF DESCRIPTION OF THE DRAWINGS

Embodiments of the present invention will be described by way of example only, and not limitation, with reference to the accompanying drawings.

FIG. 1 is a block diagram of an exemplary system, apparatus and method for a multi-tenant dashboard system for use with a robotics processing automation system according to an embodiment of the present invention;

FIG. 2 is a system architecture showing implementation of the multi-tenant dashboard system by a robotics process service provider;

FIG. 3 is a representative architecture for the multi-tenant dashboard;

FIG. 4 is a representative data structure of the multi-tenant dashboard;

FIG. 5 is a flow diagram illustrating initial tenant setup within the multi-tenant dashboard system of the present invention; and

FIG. 6 is a flow diagram illustrating an exemplary set of process steps activated, executed and completed using the triggering system of the multi-tenant dashboard of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention are directed to a multi-tenant dashboard system that allows users, across a plurality of tenants, to access, view, and report on the progress and performance of robotics processes via the multi-tenant dashboard system's user interface (“UI”). The system permits this multi-tenant access without requiring any custom code to be developed or deployed for each of the plurality of tenants or for each tenant's unique set of robotics processes. The multi-tenant dashboard system comprising a multi-tenant architecture, a multi-role architecture, one or more layered process outlines, and a triggering system.

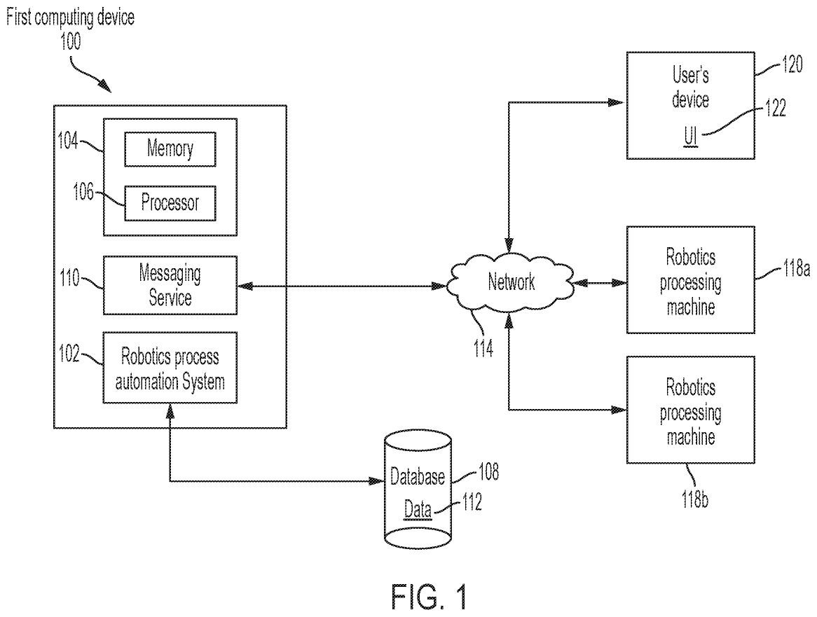

Referring now to the figures where similar reference characters denote similar elements throughout the figures, FIG. 1 illustrates a first computing device 100 comprising a robotic process automation system 102, a memory storing instructions 104, and a hardware processor 106 coupled to the memory 104 wherein the hardware processor 106 is configured by the instructions to establish at least one tenant profile with identifying information, establish one or more users within the at least one tenant profile, assign roles to each of the one or more users within the at least one tenant profile, execute a set of process steps unique to each user, and send messages through a messaging service 110 notifying the at least one tenant of the status of a robotic process.

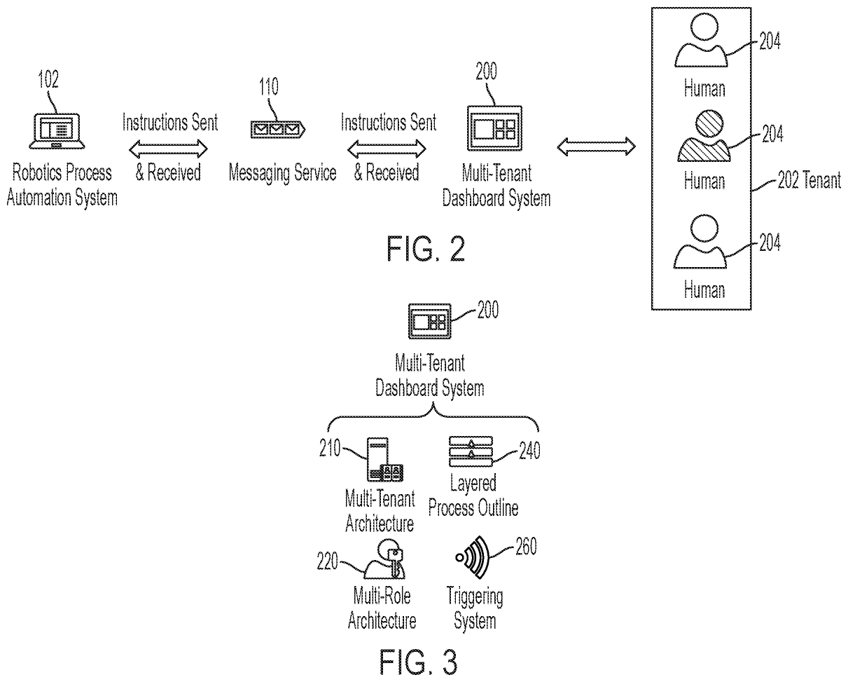

With reference to FIGS. 1 and 2, the messaging service 110 is coupled to the at least one computing device 100 and a plurality of robotics processing machines 118a, 118b via a network 114. The one or more robotics processing machines 118a, 118b controlled by the robotics process automation system 102. Information sent and received via the messaging service 110 is in any common computer file format. This may include JSON, XML or any common computer file format known to one skilled in the art. More than one computing device and more than one robotics processing machine 118 can communicate through the messaging service 110 over the network 114. See FIG. 2.

A tenant 202 generally refers to a group of users 204 that shares access to common data 112 within the database 108. By way of a non-limiting example only, a tenant may be a car manufacturer that uses a combination of users 204 (i.e. humans) and robotics processing machines 118a, 118b to execute a set of process steps 414, 416 unique to manufacturing different styles of cars. Users 204, across a plurality of tenants, access, view, and report on the progress and performance of robotics processes via the multi-tenant dashboard system's UI which is accessible to users 204 via any network connected computing device 120, including but not limited to, a desktop, laptop, and smart device, such as, a tablet and smart phone. Instructions are sent and received to and from the robotics process automation system 102 via the messaging service 110.

Referring now to FIG. 3 the multi-tenant dashboard system 200 includes a multi-tenant architecture 210, a multi-role architecture 220, one or more layered process outlines 240, and a triggering system 260. The multi-tenant architecture 210 is a system architecture in which a single instance of a software application services multiple tenants 202. The multi-tenant architecture 210 segments one customer's data and information from another's at the database, application, and presentation layers. The multi-tenant architecture 210 allows different sets of users 202 to share functionality without necessarily sharing each other's data 112. In other words, multiple tenants 202 may share access to a common server and database 108. The particular data 112 and services provided from server to each tenant 202 are encrypted and logically and securely isolated from those provided to other tenants 202. Tenants 202 may be given the ability to customize some parts of the system 102, such as color of the UI or business rules, but they cannot customize the systems' 102 code.

The multi-role architecture 220 is an architecture which distinguishes between each user 204. A user 204 is assigned a unique role defining the authority and access the user 204 has to screens, data, and actions within the robotics process automation system 102. The multi-role architecture 220 allows a tenant 202 to grant and/or restrict its users 204 access to view and edit information for its automated processes based on that user's role.

The one or more layered process outlines of the multi-tenant dashboard system allows tenants 202 to define a process and to define the complexity of each step or component of that process and subsequently use this information in comparing and evaluating a tenant's operational performance. For example, the layered process outline 240 may allow a user 204 who is assigned an Administrator role to establish one or more of the following for each automated robotic process that they want reported or controlled through the dashboard: a name for the automated robotic process; a number of components or steps to the process; and for each component or step: a name or other identifying information for the component or step; and an amount of time to complete that step.

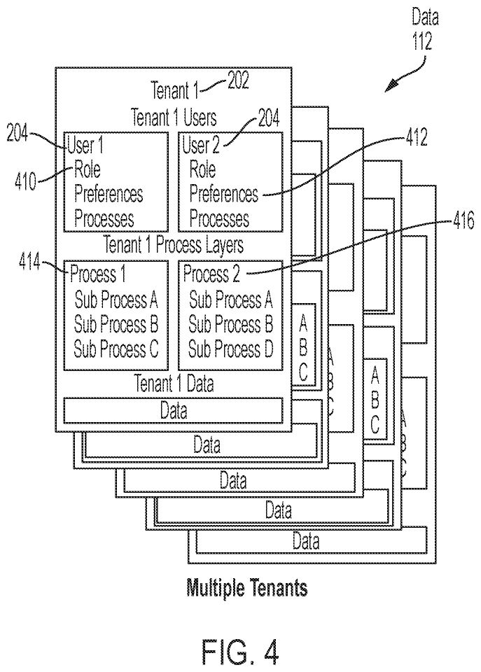

FIG. 4 shows an example of a multi-tenant data structure wherein each automated process 414, 416 comprises of a set of sub-process steps. Data 112 stored in the database 108 is segmented by tenant 202. Each user's 204 unique role and preferences are stored. The set of sub-process steps unique to each user 204 based on the role assigned is also stored. In the example shown in FIG. 4, Process steps 414 and 416 share sub processes A and B, but process steps 414 include process step C whereas process steps 416 include process step D.

Referring again to FIG. 3, the layered process outline 240 allows a tenant 202 to define a set of process steps which allows for differentiation between each unique user. Utilizing the non-limiting example noted above where the tenant is a car manufacturer and user A is assembling a 4-door sedan and user B is assembling a 2-door sports car. Both users will require certain parts such as wheels, an engine, doors, seats, and a steering wheel. However, user A will need 4 doors whereas user B will only need 2 doors. Another user, user C, may be assembling a 2-door convertible sports car which would require a removable top. Accordingly, users A, B, and C may share some similar parts and steps however, the process steps will differ when handling the differences between each type of car. Further, each car may require different features thereby requiring varying levels of expertise. For example, a base model may not include comfort features (e.g., air conditioning, heated seats, etc.). A luxury model which includes comfort features will require additional inputs and time to build and may therefore require a user with a different skill set than the user assigned the base model. The layered process outline allows for the same overarching process (i.e. building a car) for each user but includes sub-processes that require different steps. These differing steps may require a different timeframe, skillset with varying expertise, and other variables.

Access to the one or more robotics processing machines 118 may be provided via a service level agreement (SLA) between a robotics process service provider and one or more tenants 202. Multiple robotics processing machines 118 may be deployed on demand to meet an SLA due to spikes in volume where only one robotics processing machine may have been previously required to meet the SLA.

The SLA allows each tenant to dictate the amount of time allotted to complete one transaction/widget. There are two tiers of SLAs: (1) The process level SLA determines the specified period of time in which a transaction must be completed; and (2) The sub process level SLA that provides a different window of time to complete a harder transaction than a simpler transaction within the process level SLA. Using the car manufacturing example previously mentioned, the overall SLA to develop all of the trim levels for a 4-door luxury sedan might be 24 hours per car (from the point it enters the production line till the point it leaves). The SLA for the base level of this sedan might require 12 hours from start to finish whereas the SLA for the luxury level of this sedan might require 20 hours because there are more steps to complete it.

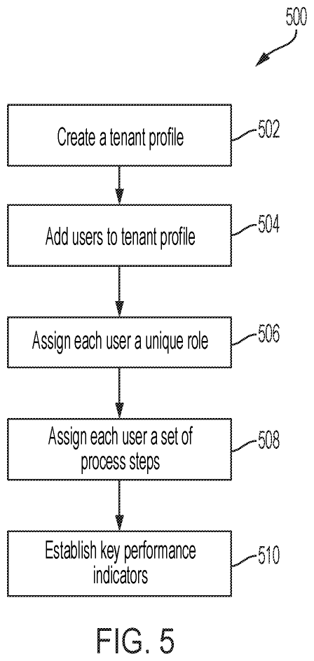

FIG. 5 is a flow diagram 500 illustrating the initial tenant setup using the multi-tenant dashboard 200. First, a tenant profile is created 502 via the multi-tenant dashboard's UI. Where the tenant is a company, the tenant profile may include the company's name, address, key contact information, a unique ID for the company, and any additional identifying information. Once a tenant profile has been established, using the multi-role feature 220, individual users are entered into the system 504. Each user's profile can include their name, e-mail address, and any further key information. By way of the multi-role architecture, each user is assigned a unique role 506 they will serve while interacting with the robotics process automation system 102 (i.e., Administrator, Manager, Associate, etc.).

During initial tenant set up, the robotics process automation system 102 is configured 510 with a plurality of Key Performance Indicators (KPIs), which provide a measurable value that demonstrates how effectively a company is achieving key business objectives. The KPIs are typically unique for each tenant such that each tenant can use the KPIs at multiple levels to evaluate the performance of the robotics process automation system. High-level KPIs may focus on the overall performance of the company, while low-level KPIs may focus on processes or employees in specific departments.

Additionally, the multi-tenant dashboard system 200 uses information received from the robotic process automation system 102 to establish a plurality of KPIs that are applicable to all types of processes. For example, KPIs may include: a number of tasks completed; a number of tasks in exception; an average time required to complete a task; and a number of hours saved utilizing the system services. At any point during the completion of the set of process steps the messaging system 110 may pass the following KPIs from the robotics process automation system 102 to the multi-tenant dashboard system 200: the Task Start and Stop Times; the Status of the Task (e.g., Started, In Progress, Completed, and Exception); and identifying detail about the task (e.g., Task ID, Process ID, Process Component/Part, etc.). The KPIs can be viewed by users 204, tenants 202 and/or converted into reports for future viewing.

The multi-tenant dashboard 200 may be utilized to view these KPIs according to a specific temporal period, for example, for a particular date, or for a particular time window (e.g. for a week, for a month or for a year). The multi-tenant dashboard 200 may also provide a comparison of a KPI value in the current time period vs. the prior period (e.g., current year vs. prior year, this week vs. last week, today vs. yesterday). The KPIs for the organization may be presented in an aggregated form to reflect performance at the tenant level. If more granularity is desired, the dashboard may be configured to view KPIs down to the process level.

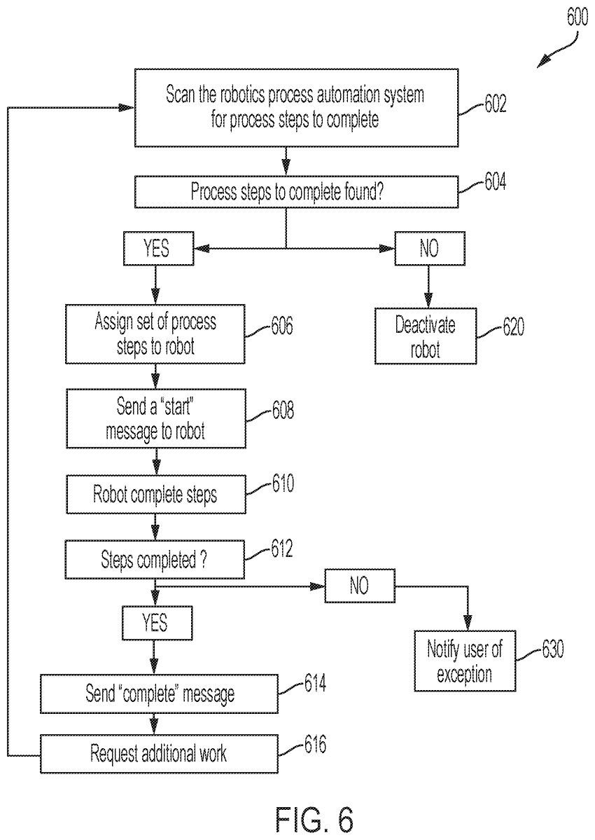

FIG. 6 is a flow diagram 600 showing an exemplary use of the triggering system 260 of the multi-tenant dashboard system 200. The triggering system 260 is a mechanism that allows one software application to initiate an action in another software application. By way of non-limiting example only, the multi-tenant dashboard system 200 may initiate an action of the one or more robotics processing machines 118 by sending a trigger instruction to the robotics process automation system 102.

Preferably, the triggering system comprises of two types of robots, supervisor robots and worker robots wherein the supervisor robots evaluate and assign the set of process steps to the worker robots and the worker robots complete the assigned set of process steps. More specifically, the supervisor robots look to see if there are any tasks to be completed. If they find tasks, they then determine the number of worker robots required based on the specific tenant's service levels and assign them accordingly. The supervisor robots request updates from the worker robots during processing. The worker robots let the supervisor robots know when they have completed processing tasks and they ask for more task. If no tasks are available, the supervisor robots put the worker robots to sleep.

In some instances, the set of process steps may be required to be completed only by a robotics processing machine 118. In other instances, the set of process steps may be required to be completed by both a robotics processing machine 118 and the user 204. In a preferred embodiment, the triggering system 260 starts a set of process steps automatically 99% of the time.

The UI of the multi-tenant dashboard system 200 which is displayed of a user's device 120, provides a view of all of the robotic processes as an indicator as to whether each one is currently active. For each robotic process that is not active, an option will appear to a user 204 through the messaging service 110 to request that it begin working. When the user 204 selects a process that is not active, the triggering system 260 sends a “start” request via the messaging service 110 to the robotic process automation system 102. In a preferred embodiment, a supervisor robot cans 602 robotics process automation system 102 for a set of process steps that need to be completed. If a set of process steps that need to be completed are found, the triggering system 260 automatically assigns 606 the set of process steps to one or more worker robots.

Once the “start” request message is received, the worker robot begins to complete 610, 612 the set of process steps. The worker robot sends a “complete” notice 614 to the supervisor robot once all the steps are done. At this point, the worker robot will request more work 616.

In instances where the supervisor robot does not find a set of process steps to complete, the supervisor robot can deactivate the worker robot until further notification 620. In some instances when the worker robot cannot complete a set of process steps due to an exception, the worker robot notifies 630 the supervisor robot of the exception and awaits further instructions. An exception represents an event that occurs during the operation of a process that prevents the robotics process automation system 102 from being able to complete a task without requiring additional input from a computer or a human. The multi-tenant dashboard system 200 may also allow the user 204 to look at the task with a status of “exception” and then assign that exception to any additional user 204 for review and to take remedial action.

The present invention includes software which may either be loaded onto a computer or accessed by a computer. The loaded software may include an application on a smart device. A computer may access the software via the web browser using the internet, extranet, intranet, host server, internet cloud and the like.

The system and method described herein is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail.

It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries.

To the extent the present invention discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention.

What is claimed is:

1. A system providing a multi-tenant dashboard for allowing tenants to execute and evaluate an automated software system, comprising:
a. one or more robotics processing machines;
b. a robotic process automation system operating on a first computing device configured to execute a set of business rules using one or more of the robotics processing machines, the first computing device, comprising:
i. a memory storing instructions; and
ii. a hardware processor coupled to the memory wherein the hardware processor is configured by the instructions to:
a) establish at least one tenant profile with identifying information;
b) establish one or more users within the at least one tenant profile
b) assign roles to each of the one or more users within the at least one tenant profile;
c) execute a set of process steps unique to each user; and
d) send messages through a messaging system notifying the at least one tenant of status of the automation system.

2. The system of claim 1, wherein the system includes a multi-role architecture that assigns the at least one user a unique role defining the at least one user's accessibility within the system, and wherein the role assigned to the at least one user grants or denies access to view and edit information of the robotic process automation system through the multi-tenant dashboard.

3. The system of claim 2, wherein the set of process steps is unique to each user based on the unique role assigned.

4. The system of claim 2, wherein the set of process steps unique to each user is assigned based on a tag.

5. The system of claim 1, wherein the system further comprises a triggering system which comprises of two or more robots, the triggering system for starting a set of process steps automatically.

6. The system of claim 5, wherein the triggering system comprises a method of completing the set of process steps, the method comprising: prompting a first robot to search the robotics process automation system for a set of process steps that need to be completed; assigning a second robot a task of completing the process steps; sending a start request through the messaging system to the second robot to begin completion of the process steps; and the second robot notifying the first robot through the messaging system when the process steps are complete.

7. The system of claim 6, wherein the method further includes the first robot temporarily deactivating the second robot when there are no process steps to complete.

8. The system of claim 6, wherein the method further includes the second robot notifying the first robot when an exception has occurred, and the process steps cannot be completed.

9. The system of claim 1, wherein the processor is further configured by the instructions to define a set of key performance indicators unique to the at least one tenant that indicate the performance of the robotics process automation system.

10. The system of claim 9, wherein the set of key performance indicators may be viewed by the at least one tenant via the multi-tenant dashboard for a specified time period, as a comparison between current time period versus a prior time period, and as an aggregation of completed process steps.

11. The system of claim 1, wherein the set of process steps allows for differentiation between each user, such that one or more of the process steps are the same between a first and second user and one or more of the process steps are different between the first and second user.

12. A system providing a multi-tenant dashboard for allowing tenants to execute and evaluate an automated software system, comprising:
a. one or more robotics processing machines;
b. a robotic process automation system operating on a first computing device configured to execute a set of business rules using one or more of the robotics processing machines, the first computing device, comprising:
i. a memory storing instructions; and
ii. a processor coupled to the memory wherein the processor is configured by the instructions to:
a) establish at least one tenant profile with identifying information;
b) establish one or more users within the at least one tenant profile
b) assign roles to each of the one or more users within the at least one tenant profile;
c) define key performance indicators stored within the memory;
d) allocate a set of process steps unique to each user;
e) activate a triggering system comprising two or more robots, to evaluate and complete the set of process steps; and
e) send messages through a messaging system notifying tenants of status of the robotics process automation system based on execution of the set of process steps.

13. The system of claim 12, wherein the system includes a multi-role architecture that assigns the at least one user a unique role defining the at least one user's accessibility within the system, and wherein the role assigned to the at least one user grants or denies access to view and edit information of the robotics process automation system through the multi-tenant dashboard.

14. The system of claim 12, wherein the triggering system comprises a method of completing the set of process steps, the method comprising: prompting a first robot to search the robotics process automation system for a set of process steps that need to be completed; assigning a second robot a task of completing the process steps; sending a start request through the messaging system to the second robot to begin completion of the process steps; and the second robot notifying the first robot through the messaging service when the process steps are complete.

15. The system of claim 14, wherein the method further includes the first robot temporarily deactivating the second robot when there are no process steps to complete.

16. The system of claim 14, wherein the method further includes the second robot notifying the first robot when an exception has occurred, and the process steps cannot be completed.

17. The system of claim 12, wherein the set of process steps allows for differentiation between each user, such that one or more of the process steps are the same between a first and second user and one or more of the process steps are different between the first and second user.

18. A computer-implemented method for monitoring the performance of an automated processing system, comprising:
a) establish at least one tenant profile with identifying information;
b) establish one or more users within the at least one tenant profile;
c) assign a role to each of the one or more users within the at least one tenant profile;
d) define key performance indicators stored within the memory;
e) allocate a set of process steps unique to each user;
f) activate a triggering system to complete the set of process steps; and
g) send messages through a messaging system notifying tenants of status of the automated processing system based on execution of the set of process steps.

19. The computer-implemented method of claim 18, wherein the system includes a multi-role architecture that assigns the at least one user a unique role defining the at least one user's accessibility within the system, and wherein the role assigned to the at least one user grants or denies access to view and edit information of the automation system through a user interface of the multi-tenant dashboard.

20. The computer-implemented method of claim 18, wherein the triggering system comprises a method of completing the set of process steps, the method comprising: prompting a first robot to search the robotics process automation system for a set of process steps that need to be completed; assigning a second robot a task of completing the process steps; sending a start request through the messaging system to the second robot to begin completion of the process steps; and the second robot notifying the first robot through the messaging service when the process steps are complete.
